(19) United States
(12) Patent Application Publication
(10) Pub. No.: US 2023/0276790 A1
(43) Pub. Date: Sep. 7, 2023

(54) HYPOTHERMIC PRESERVING DILUENT, HYPOTHERMIC PRESERVING METHOD OF PLECTROPOMUS LEOPARDUS SEMEN AND APPLICATION THEREOF

(71) Applicants: Sanya Nanfan Research Institute of Hainan University, Sanya (CN); Hainan University, Haikou (CN)

(72) Inventors: Xin WEN, Haikou (CN); Jian LUO, Haikou (CN); Jie HUANG, Haikou (CN); Xin FAN, Haikou (CN); Kexin ZHOU, Haikou (CN); Min YANG, Haikou (CN); Weiwei ZHANG, Haikou (CN)

(21) Appl. No.: 18/098,456

(22) Filed: Jan. 18, 2023

(30) Foreign Application Priority Data
Jan. 28, 2022 (CN) 202210107918.0

(51) Int. Cl. A01N 1/02

(52) U.S. Cl. CPC A01N 1/0226; A01N 1/0284

(57) ABSTRACT

Disclosed are a hypothermic preserving diluent, a hypothermic preserving method of Plectropomus leopardus semen, and an application thereof, belonging to the technical field of artificial breeding of Plectropomus leopardus, where the hypothermic preserving diluent includes the following components in parts by weight: 3.5 parts of sodium chloride, 1.68 parts of sodium bicarbonate, 2 parts of potassium chloride, 2 parts of reduced glutathione, 0.44 parts of glucose, and 10 parts of fetal bovine serum (FBS), and the Plectropomus leopardus semen is diluted with the diluent according to a dilution ratio of 1:9-1:99, and preserved at 0-4 degree Celsius (° C.).

### CROSS-REFERENCE TO RELATED APPLICATIONS

This application claims priority to Chinese Patent Application No. 202210107918.0, filed on Jan. 28, 2022, the contents of which are hereby incorporated by reference.

### TECHNICAL FIELD

The present disclosure relates to the technical field of artificial breeding of Plectropomus leopardus, and in particular to a hypothermic preserving diluent, a hypothermic preserving method of Plectropomus leopardus semen, and an application thereof.

### BACKGROUND

Fish reproduce in vitro, as sperms are inactive in the spermatozoa or seminal plasma and are activated as soon as they are discharged into the water, where they begin to move and perform fertilization. Plectropomus leopardus, also known as leopard coral trout, is a valuable mariculture species cultured along the southern coast; in pursuit of profit maximization, many breeding plants have gradually increased their breeding densities, resulting in the deepening of inbreeding and further making problems such as germplasm degradation and diseases rather serious.

An effective means of preserving sperm in-vitro allows for the possibility of artificial insemination or even full artificial breeding. In actual production, there are often problems such as incompatibly developed male and female gonads or insufficient amount of semen in male fish, then a method of short-term preservation of semen for several days or even tens of days is required. Apart from that, sperms discharged from parental fish stop moving soon after they lose the supply of nutrients from the organism and the energy required comes from seminal plasma only. Therefore, sperms should be obtained without contamination and preserved at low temperatures (0-4 degree Celsius (° C.)) to reduce energy consumption, and appropriate diluents are necessary to reduce sperm viscosity, maintain internal environmental homeostasis, and supplement nutrition, so as to effectively prolong sperm preservation in vitro; yet, the preservation is still affected by the dilution times, for inadequate times result in low viability due to high concentration and viscosity of the semen, and excessive dilutions cause changes in the external morphology and structure of the sperm.

So far, no report or study on hypothermic preservation (0-4° C.) of Plectropomus Leopardus sperm has been found, except for the “Freezing protection solution and preservation method of Plectropomus leopardus sperms” (Patent No. CN104304234A) by Meng Zining's team from Sun Yat-sen University; Meng's report is provided only for cryopreservation and the operation is too sophisticated, as farms are not always equipped with liquid nitrogen and liquid nitrogen tanks; besides, there are differences among different personnel in operation, and the thawing duration of frozen sperm is subjectively influenced, which will directly affect the effect of sperm cryopreservation, even though some sperm remain viable after thawing, their internal and external physiological and biochemical functions are still damaged by freezing, resulting in no ability to fertilize.

### SUMMARY

The present disclosure provides a hypothermic preserving diluent, a hypothermic preserving method of Plectropomus leopardus semen, and an application thereof, with objectives of solving the problems existing in the prior art. The hypothermic preserving diluent provided by the present disclosure fulfills the requirements for short-term storage of sperm at low temperature for the artificial breeding of Plectropomus leopardus by extending the cryopreservation duration and improving the fertilization rate and hatching rate.

To achieve the above objectives, the present disclosure provides the following technical schemes:
a hypothermic preserving diluent of Plectropomus leopardus semen, including the following components in parts by weight:
3.5 parts of sodium chloride, 1.68 parts of sodium bicarbonate, 2 parts of potassium chloride, 2 parts of reduced glutathione, 0.44 parts of glucose, and 10 parts of fetal bovine serum (FBS).

The components in this formula are suitable for the cryopreservation of Plectropomus Leopardus semen; inorganic salts are used for maintaining pH and osmotic pressure, as well as inhibiting sperm activation, and glucose is added as an external source of nutrients; the reduced glutathione decreases oxidative damage caused by metabolites produced during respiratory metabolism of sperm; and FBS, in addition to the above functions, reduces hypothermic damage produced by sperm under low temperatures.

The present disclosure also provides a hypothermic preserving method of Plectropomus leopardus semen using the hypothermic preserving diluent, including steps of diluting the Plectropomus leopardus semen with the hypothermic preserving diluent according to a dilution ratio of 1:9-1:99, and preserving at 0-4 degree Celsius (° C.).

Optionally, the hypothermic preserving method also includes steps of preparing the hypothermic preserving diluent illustrated as follows:
S1, weighing sodium chloride, sodium bicarbonate, potassium chloride, reduced glutathione and glucose according to a dosage of each component, dissolving in ultra-pure water at a normal temperature to prepare a base diluent, and storing at 4° C. for later use; and
S2, mixing the base diluent with FBS according to a volume ratio of 1:9 to obtain the diluent.

Optionally, the ultra-pure water is subjected to high-temperature sterilization at 120° C. for 30 minutes (min).

Optionally, the base diluent is kept at 4° C. for no more than 7 days.

Optionally, the FBS is thawed and completely dissolved before application, then mixed with the base diluent to ensure that the FBS is ready for use.

The present disclosure also provides an application of the hypothermic preserving diluent in prolonging in-vitro storage duration of the Plectropomus leopardus semen and improving the semen in terms of fertilization rate and hatching rate after in-vitro storage.

The present disclosure achieves the following technical effects:
the formula of hypothermic preserving diluent for semen provided by the present disclosure has no toxic effect on sperm, and the in-vitro preservation of sperm is effectively prolonged up to 3 days by applying with the hypothermic preserving method and the application of the hypothermic preserving diluent;
the hypothermic preserving method is easy to operate; after preparing the hypothermic preserving diluent, the sperm can be preserved in the field with an ice bag to avoid damage to the sperm due to the formation of ice crystals when the sperm is under a temperature below 0° C.; and
according to the present disclosure, parental sperm of high quality can be preserved efficiently, and the fertilization rate and hatching rate of diluted semen after in vitro preservation are improved, which provides technical support to individuals, enterprises and research units for artificial insemination of Plectropomus leopardus as well as meeting the requirements of production research.

### BRIEF DESCRIPTION OF THE DRAWING

FIG. 1 illustrates an operating process of preserving Plectropomus leopardus semen using a hypothermic preserving diluent provided by the present disclosure.

### DETAILED DESCRIPTION OF THE EMBODIMENTS

Now, various exemplary embodiments of the present disclosure will be described in detail. This detailed description should not be taken as a limitation of the present disclosure, but should be understood as a more detailed description of some aspects, characteristics and embodiments of the present disclosure.

It should be understood that the terms mentioned in the present disclosure are only used to describe specific embodiments, and are not used to limit the present disclosure. In addition, for the numerical range in the present disclosure, it should be understood that each intermediate value between the upper limit and the lower limit of the range is also specifically disclosed. Every smaller range between any stated value or the intermediate value within the stated range and any other stated value or the intermediate value within the stated range is also included in the present disclosure. The upper and lower limits of these smaller ranges may be independently included or excluded from the range.

Unless otherwise stated, all technical and scientific terms used herein have the same meanings commonly understood by those of ordinary skill in the field to which this disclosure relates. Although the present disclosure only describes preferred methods and materials, any methods and materials similar or equivalent to those described herein can be used in the practice or testing of the present disclosure. All documents mentioned in this specification are incorporated by reference to disclose and describe the methods and/or materials related to the documents. In case of conflict with any incorporated documents, the contents of this specification shall prevail.

Without departing from the scope or spirit of the present disclosure, it is obvious to those skilled in the art that many modifications and changes may be made to the specific embodiments of the present specification. Other embodiments obtained from the description of the present disclosure will be obvious to the skilled person. The specification and embodiment of this application are only exemplary.

As used in this paper, the terms “comprising”, “including”, “having” and “containing” are all open terms, meaning including but not limited to.

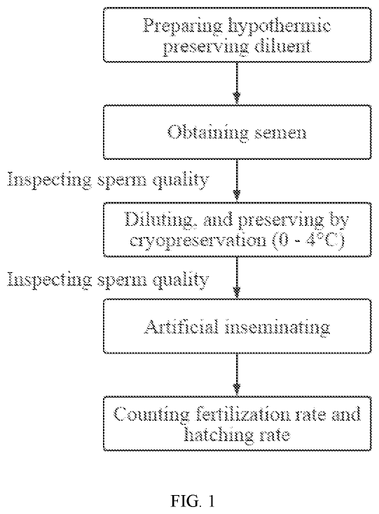

According to the technical schemes of the present disclosure, the Plectropomus Leopardus semen is preserved using a hypothermic preserving diluent as shown in FIG. 1, including:
(1) preparing the hypothermic preserving diluent;
(2) obtaining semen (with semen quality inspection);
(3) diluting, and preserving by cryopreservation (0-4 degree Celsius (° C.)), and inspecting sperm quality;
(4) artificial inseminating; and
(5) counting a fertilization rate and a hatching rate.

### Embodiment 1 Preparation of Hypothermic Preserving Diluent for Plectropomus leopardus Semen

1. Sodium chloride 3.5 grams (g), sodium bicarbonate 1.68 g, potassium chloride 2 g, reduced glutathione 2 g, glucose 0.44 g are weighed on an analytical balance, dissolved in ultra-pure water that has been sterilized in an autoclave at 120° C. for 30 minutes (min) at a room temperature, and fixed the volume to 0.9 liter (L) to obtain a base dilution, which is stored at 4° C. for later use, with a best storage duration of no more than 7 days.

2. Before application, fetal bovine serum (FBS) is taken out at −20° C. until completely dissolved and then 0.1 L is pipetted into the base diluent to obtain the hypothermic preserving diluent.

### Embodiment 2 Collection and Dilution of Semen

1. During the breeding season, 20 male Plectropomus leopardus with good growth and mature spermary are selected after nutritional fortification, anesthetized with eugenol, dried around the cloaca with a dry towel, and gently pressed on the abdomen from the head of the fish to the cloaca, and after the flow of milky white, clean and uncontaminated semen, the semen is immediately aspirated using a pipette with a range of 200 microliters (μL) and gently tapped into the bottom of a sterile 5 milliliters (mL) EP tube without any liquid, and the collected semen of Plectropomus leopardus are mixed and processed in order to eliminate inter-individual differences.

2. Semen is diluted with the hypothermic preserving diluent prepared in Embodiment 1 at the ratios of 1:9, 1:29, 1:49, 1:69, and 1:99 into 5 mL sterile EP tubes, which are designated as the experimental group, and the total volume of each diluted semen is 2.1 mL. The remaining fresh semen without any reagent is used as the control group.

3. All the above EP tubes are first wrapped in tin foil to avoid light and prevent light activation, then wrapped in skimmed cotton, with the outermost gauze wrapped tightly, and placed in an ice box containing an ice pack at a temperature of about 4° C.

### Embodiment 3 Sperm Vitality Test

1. Detection of fresh sperm vitality: in accordance with the fresh sperm collected in step 2 of Embodiment 2, tests are conducted at 10 min, 2 hours (h), 4 h, 6 h, 12 h, 24 h, 48 h, 72 h and 96 h after removal from the parental male fish, and each test is performed as follows: 99 μL of hypothermic preserving diluent for Plectropomus leopardus semen is added to a 200 μL EP tube with a 200 μL pipette, 1 μL of fresh semen is aspirated with a 2.5 μL pipette and gently blown and mixed; 1 μL of the mixture is aspirated onto a slide, the focal length is adjusted until the display is clear, 2 μL of filtered natural seawater is added to activate the sperm, the final semen is diluted 300 times and then a computer-aided sperm analysis (CASA) is applied to detect sperm motility, with motility being recorded mainly.

2. Detection of Semen with Different Dilution Ratios

(1) When the semen prepared according to step 2 in Embodiment 2 with a dilution ratio of 1:9 (diluted 10 times) is tested, tests are performed at 10 min, 2 h, 4 h, 6 h, 12 h, 24 h, 48 h, 72 h and 96 h after removal from the parental male fish, and each test is performed as follows: 9 μL of hypothermic preserving diluent for Plectropomus leopardus semen is added to a 200 μL EP tube with a 10 μL pipette, 1 μL of diluted semen prepared according to step 2 in Embodiment 2 with a dilution ratio of 1:9 is aspirated with a 2.5 μL pipette and gently blown and mixed; 1 μL of the mixture is aspirated onto a slide, the focal length is adjusted until the display is clear, 2 μL of filtered natural seawater is added to activate the sperm, the final semen is diluted 300 times and then the CASA is applied to detect sperm motility, with motility being recorded mainly.

(2) When the semen prepared according to step 2 in Embodiment 2 with a dilution ratio of 1:29 (diluted 30 times) is tested, tests are performed at 10 min, 2 h, 4 h, 6 h, 12 h, 24 h, 48 h, 72 h and 96 h after removal from the parental male fish, and each test is performed as follows: 2.8 μL of hypothermic preserving diluent for Plectropomus leopardus semen is added to a 200 μL EP tube with a 2.5 μL pipette, 1.2 μL of diluted semen prepared according to step 2 in Embodiment 2 with a dilution ratio of 1:29 is aspirated with a 2.5 μL pipette and gently blown and mixed; 1 μL of the mixture is aspirated onto a slide, the focal length is adjusted until the display is clear, 2 μL of filtered natural seawater is added to activate the sperm, the final semen is diluted 300 times and then the CASA is applied to detect sperm motility, with motility being recorded mainly.

(3) When the semen prepared according to step 2 in Embodiment 2 with a dilution ratio of 1:49 (diluted 50 times) is tested, tests are performed at 10 min, 2 h, 4 h, 6 h, 12 h, 24 h, 48 h, 72 h and 96 h after removal from the parental male fish, and each test is performed as follows: 1 μL of hypothermic preserving diluent for Plectropomus leopardus semen is added to a 200 μL EP tube with a 2.5 μL pipette, 1 μL of diluted semen prepared according to step 2 in Embodiment 2 with a dilution ratio of 1:49 is aspirated with a 2.5 μL pipette and gently blown and mixed; 1 μL of the mixture is aspirated onto a slide, the focal length is adjusted until the display is clear, 2 μL of filtered natural seawater is added to activate the sperm, the final semen is diluted 300 times and then the CASA is applied to detect sperm motility, with motility being recorded mainly.

(4) When the semen prepared according to step 2 in Embodiment 2 with a dilution ratio of 1:69 (diluted 70 times) is tested, tests are performed at 10 min, 2 h, 4 h, 6 h, 12 h, 24 h, 48 h, 72 h and 96 h after removal from the parental male fish, and each test is performed as follows: 0.6 μL of hypothermic preserving diluent for Plectropomus leopardus semen is added to a 200 μL EP tube with a 2.5 μL pipette, 1.4 μL of diluted semen prepared according to step 2 in Embodiment 2 with a dilution ratio of 1:69 is aspirated with a 2.5 μL pipette and gently blown and mixed; 1 μL of the mixture is aspirated onto a slide, the focal length is adjusted until the display is clear, 2 μL of filtered natural seawater is added to activate the sperm, the final semen is diluted 300 times and then the CASA is applied to detect sperm motility, with motility being recorded mainly.

(5) When the semen prepared according to step 2 in Embodiment 2 with a dilution ratio of 1:99 (diluted 100 times) is tested, tests are performed at 10 min, 2 h, 4 h, 6 h, 12 h, 24 h, 48 h, 72 h and 96 h after removal from the parental male fish, and each test is performed as follows: diluted semen prepared according to step 2 in Embodiment 2 with a dilution ratio of 1:99 is aspirated with a 2.5 μL pipette and gently blown and mixed; 1 μL of the mixture is aspirated onto a slide, the focal length is adjusted until the display is clear, 2 μL of filtered natural seawater is added to activate the sperm, the final semen is diluted 300 times and then the CASA is applied to detect sperm motility, with motility being recorded mainly.

The results of sperm motility tests according to the above methods are shown in Table 1, from where it can be seen that as compared to fresh sperm, the motility of activated sperm is relatively high and greatly prolonged when the dilution ratios of Plectropomus leopardus semen and hypothermic preserving diluent are 1:49 and 1:69, and the motility is about 10 percent (%) after 72 h of preservation, by then most of the sperm are already inactivated, and even the motile sperms are not able to be properly fertilized with the egg. Therefore, it may be inferred that the maximum preservation duration of the hypothermic preserving diluent of the Plectropomus Leopardus semen proposed in the present disclosure is about 3 days. In order to improve the efficiency of preservation after each semen collection, a dilution ratio of 1:49 is preferred.

TABLE 1
Sperm motility of Plectropomus Leopardus at different
preservation duration and dilution ratio

| Dilution | 10 min | 2 h | 4 h | 6 h | 12 h | 24 h | 48 h | 72 h | 96 h |
|---|---|---|---|---|---|---|---|---|---|
| ratios | (%) | (%) | (%) | (%) | (%) | (%) | (%) | (%) | (%) |
| Fresh semen | 95.90 | 74.91 | 55.38 | 24.10 | — | — | — | — | — |
| 1:9 | 94.28 | 86.82 | 80.68 | 77.64 | 67.34 | 37.83 | 22.58 | 9.42 | — |
| 1:29 | 95.35 | 87.39 | 82.04 | 78.15 | 68.88 | 38.25 | 27.29 | 9.46 | — |
| 1:49 | 94.65 | 87.64 | 84.30 | 81.67 | 72.91 | 47.51 | 33.31 | 14.33 | 5.70 |
| 1:69 | 94.37 | 85.30 | 81.47 | 79.68 | 71.54 | 44.60 | 31.83 | 12.28 | 5.75 |
| 1:99 | 92.92 | 82.41 | 77.44 | 74.23 | 65.22 | 35.61 | 21.45 | 9.45 | — |

Note:
“—” means inactivation, i.e. the motility is 0.

### Embodiment 4 Artificial Insemination

According to the results obtained in Embodiment 3, the preservation duration of Plectropomus leopardus semen with a dilution ratio of 1:49 to hypothermic preserving diluent reaches about 72 h, and remains 47.51% of the sperm activated by 24 h. Therefore, a 50-fold dilution of semen is used as the experimental group and fresh semen is used as the control group in the artificial insemination experiment.

By the method of wet insemination, 1 μL of fresh sperm or 50 μL of diluted sperm is activated with seawater and immediately poured into 2 mL of eggs laid flat on a Petri dish containing activated sperm for several minutes, stirred continuously, and then transferred to clean seawater at 26-28° C. for incubation. The eggs are fertilized at 2 h, 6 h, 12 h and 24 h respectively after preservation and the fertilization rate and hatching rate are counted, where a specific formula is as follows:

a fertilization rate=(number of embryos developed to the 4-16 cell stage/total number of eggs)×100%;

a hatching rate=(number of newly hatched larvae/number of fertilized embryos)×100%.

In particular, the eggs extruded from the parental females should be well developed, spherical in appearance, homogeneous and transparent, and most of them float on the surface of the seawater.

Based on the above artificial insemination, the fertilization rate and hatching rate of different preservation durations are measured, and the results are shown in Table 2, which shows that the fertilization ability of diluted semen is comparable to that of fresh semen after 2 h of low temperature preservation; the fertilization rate of fresh semen of Plectropomus leopardus decreases rapidly at 6 h, but the diluted semen still has high fertilization rate and hatching rate at 24 h of low temperature preservation, which are 71.54% and 64.84% respectively, remaining qualified for actual production.

TABLE 2
Fertilization rate and hatching rate after artificial insemination
at different preservation durations and dilution ratios

| Preservation | Dilution | Fertilization | Hatching |
|---|---|---|---|
| duration | ratios | rate (%) | rate (%) |
| 2 h | Fresh semen | 89.56 | 83.14 |
| | 1:49 | 93.48 | 85.65 |
| 6 h | Fresh semen | 54.25 | 79.46 |
| | 1:49 | 90.54 | 88.21 |
| 12 h | Fresh semen | — | — |
| | 1:49 | 86.67 | 87.29 |
| 24 h | Fresh semen | — | — |
| | 1:49 | 71.54 | 64.84 |

Note:
“—” means that the fertilization rate or hatching rate is 0.

The above-mentioned embodiments only describe the preferred mode of the present disclosure, but do not limit the scope of the present disclosure. On the premise of not departing from the design spirit of the present disclosure, all kinds of modifications and improvements made by ordinary technicians in the field to the technical schemes of the present disclosure shall fall within the scope of protection determined by the claims of the present disclosure.

What is claimed is:

1. A hypothermic preserving diluent of Plectropomus leopardus semen, comprising:
3.5 grams (g) of sodium chloride, 1.68 g of sodium bicarbonate, 2 g of potassium chloride, 2 g of reduced glutathione, and 0.44 g of glucose weighted and dissolved in ultra-pure water sterilized in an autoclave at 120 degree Celsius (° C.) for a duration of 30 minutes (min) at a normal temperature, followed by fixing a volume to 0.9 liter (L) to obtain a base dilution and storing at 4° C. for later use;
wherein before application, fetal bovine serum (FBS) is taken out at −20° C. until completely dissolved and then 0.1 L is pipetted into the base diluent to obtain the hypothermic preserving diluent.

2. A hypothermic preserving method of Plectropomus leopardus semen using the hypothermic preserving diluent according to claim 1, comprising: diluting the Plectropomus Leopardus semen with the hypothermic preserving diluent according to a dilution ratio of 1:9-1:99, and preserving at 0-4° C.

3. The method according to claim 2, wherein the method also comprises steps of preparing the hypothermic preserving diluent:
S1, weighing 3.5 g of sodium chloride, 1.68 g of sodium bicarbonate, 2 g of potassium chloride, 2 g of reduced glutathione and 0.44 g of glucose, dissolving in ultra-pure water sterilized in an autoclave at 120° C. for 30 min at a normal temperature, followed by fixing a volume to 0.9 L to obtain a base dilution and storing at 4° C. for later use; and
S2, mixing the base diluent with FBS according to a volume ratio of 1:9 to obtain the diluent.

4. The method according to claim 3, wherein the base diluent is conserved at 4° C. for no more than 7 days.

5. The method according to claim 3, wherein the FBS is thawed and completely dissolved before application, and then mixed with the base diluent to ensure readiness for use.

6. An application of the hypothermic preserving diluent according to claim 1 in prolonging in-vitro conservation duration of Plectropomus leopardus semen and in improving the semen in terms of a fertilization rate and a hatching rate after in-vitro preservation.
